(19) United States
(12) Patent Application Publication
(10) Pub. No.: US 2010/0101470 A1
(43) Pub. Date: Apr. 29, 2010

(54) TOOL FOR THE MANUFACTURE OF FLAT TEXTILES

(75) Inventors: Bernd HILLENBRAND, Albstadt (DE); Roland Vogler, Albstadt (DE); Hans Werner Moser, Albstadt (DE); Eckhard Fehrenbacher, Tubingen (DE)

Correspondence Address: FITCH, EVEN, TABIN & FLANNERY, P. O. BOX 18415, WASHINGTON, DC, 20036, US

(73) Assignee: GROZ-BECKERT KG, Albstadt (DE)

(21) Appl. No.: 12/608,493

(22) Filed: Oct. 29, 2009

(30) Foreign Application Priority Data
Oct. 29, 2008 (EP) 08 167 874.0

(51) Int. Cl. D05C 15/22; B05D 1/36; B05D 1/08; C23C 4/12

(52) U.S. Cl. 112/80.5; 427/402; 427/404; 427/446

(57) ABSTRACT

A tool 1 for a textile machine with the tool having a wear-minimizing coating on its basic tool body 2, which wear-minimizing coating acts as an anti-wear element 15. In order to accommodate this coating, the basic tool body 2 is provided with a recess at a suitable location, and the coating is built up on the bottom of the recess, for example, by plasma-spraying. Preferably, an oxide-ceramic material is used for the coating.

### CROSS-REFERENCE TO RELATED APPLICATION

This application claims the benefit of foreign priority under 35 U.S.C. §119 based on European Patent application No. 08 167 874.0, filed Oct. 29, 2008, the entire disclosure of which application is hereby incorporated by reference.

### BACKGROUND OF THE INVENTION

The invention relates to tools for a tufting machine or another textile machine that is subjected to increased wear in the course of the process of manufacturing flat textiles. In particular, the invention relates to loop grippers that temporarily grasp one or more loops that have been punched through a carrier material, and that knives associated with the loop grippers cut the grasped loops. Tools in accordance with the invention may also be needles, parts of needles, optional components, and all parts that are essentially used for the formation or processing of stitches and loops.

For example, large numbers of loop grippers are used, in particular, in tufting machines. Usually, these loop gripers have a gripper body with a holding section and with a loop-grasping section that extends like a finger away form the holder section. In many cases the gripper body consists of a flat sheet-metal part that has flat sides and narrow sides. Frequently, the loop gripper also interacts with a cutting knife that is disposed to cut open the loops picked up by the gripper.

Such a loop gripper has been known, for example from German patent document DE 23 41 567 A. This publication discloses a loop gripper that is hook-shaped. The hook-shaped end that is set up to pick up loops is covered with small plates of wear-resistant material such as, for example, hard metal or wear-resistant steel. The small plates are soldered to the gripper body.

German patent Document DE 28 23 408 C3 also discloses a loop gripper with a soldered-in hard metal part.

In order to overcome the disadvantages connected with these solutions, it has been further suggested to secure the hard metal insert in the loop gripper without soldering and in a positive-locking manner. Regarding this, reference is made to document European patent document EP 1 953 289 A1 that shows a loop gripper with a body having a flat recess on one of its flanks. This recess forms a pocket for the accommodation of the hard metal part. This part is deformed in a plastic manner on opposing locations of the edge and comes into engagement with the recesses of the hard metal part in order to secure said part in its pocket.

The advantage of this solution consists in that micro-movements between the stiff hard metal insert and the comparably more elastic gripper body are possible. The gripper body remains flexible, whereby the bending stress is largely kept away from the hard metal insert. However, the solution finds its limits when the insert is very brittle so that it could be damaged when the pocket edge is being deformed.

It is the object of the invention to provide a tool and a manufacturing process therefore, whereby the possible choices of materials are to be increased.

### SUMMARY OF THE INVENTION

The above object generally is achieved with the tool in accordance with the invention, as well as with the manufacturing process in accordance with the invention.

The tool in accordance with the invention has a basic body that comprises a region that preferably has an indentation or recess in which a spray-deposited coating is provided. Whereas the basic tool body consists of a first material, the spray-deposited coating consists of a different, preferably harder and more wear-resistant, material. The region that has the indentation, for example in the form of a pocket, is preferably provided on a flat side of the basic tool body. The pocket in this region may be a flat indentation that has a depth of a few tenths of a millimeter, for example a depth of only two tenths of a millimeter. The pocket may have a flat, e.g., plane, bottom and a peripheral edge. This peripheral edge may have several discontinuities. As is preferred, the pocket may have a discontinuous edge that, for example, is open, i.e., is missing, toward the lower narrow side of the tool. In other words, the pocket may be open in addition to the narrow side of the tool. Moreover, it is at least possible—even though presently not preferred—for the pocket to extend around a narrow side of the tool over the two flat, oppositely projecting, sides of the basic tool body.

It is also possible for the pocket to have a depth of zero millimeters with the result that the region and the pocket display identical features. Then, the pocket is part of the flat side of the tool. In other words, the bottom of the pocket is identical to the flat side of the tool. As a result, the wear-resistant material is bonded to the flat side of the tool. As a rule, the region, in which the pocket is arranged, is in contact with the stitch or the loop. Thus, said region is the region of pick-up or of contact of the stitch or loop.

The coating that is spray-deposited in the pocket has a minimal thickness, whereby, however, the coating is tightly bonded to the material of the body of the tool. The entire area spray-deposited coating adheres tightly to the basic body of the tool. Preferably, the coating has a surface configuration that is smooth and plane, or even follows rounded areas of the basic tool body. The layer thickness of the coating is preferably uniform over the entire coated area. Potentially, the thickness of the coating may vary in an edge zone toward the edge, for example, decrease or increase.

Due to the low thickness of the coating and the intimate positive material fit between the coating and the body of the tool, it is also possible to use a brittle hard material as the coating. In addition, it becomes possible to produce very slim tools that, measured from flat side to flat side, display only an extremely low thickness. Despite the use of a brittle hard material such as, for example, a metal oxide or an oxide ceramic, these are still somewhat flexible as the coating and permit, e.g., the production of particularly fine flat textiles.

The coating applied inside the pocket thus represents an anti-wear element that, in view of its anti-wear effect is comparable to the hard metal elements that have been used in prior-art technology. The anti-wear element is applied by a spray-depositing process such as, for example, plasma-spraying, flame-spraying, arc-spraying. Said element is inherently adhesive, without the aid of auxiliary substances. Neither solder nor adhesive is required. Likewise, any subsequent mechanical machining operations such as, for example, plastic deformations of the edge of the pocket, are not necessary in order to secure the anti-wear element.

Between the anti-wear element created by the coating and the basic tool body, there is a good and intimate bond due to adhesion. During the production of the coating, the thermal stress on the body of the tool is low.

As a result of the tight bond between the anti-wear element formed by the coating and the basic tool body, a one-piece component is created. There is no longer any concern that the anti-wear element will fall out. The anti-wear layer may be selected from a large range of possible materials that cannot by themselves be used as individual solids. For example, the coating may be an oxide-ceramic material. Materials that can be used are Al₂O₃, a mixture of Al₂O₃ and TiO₂, CrO₂, TiO₂, ZrO₂, Y₂O, a mixture of HfO₂ and Y₂O₃, Cr₂C₃ and other oxides and/or carbides. It is also possible to apply metallic coatings such as those consisting, for example, of tungsten, chromium, titanium or other metals or metal alloys.

The coating surface obtained by plasma-spraying, arc-spraying or flame-spraying can be subsequently ground, polished, lapped or otherwise machined. In particular, it is possible to provide the coating with functional structures such as, for example, a cutting edge or a sliding surface for a cutting knife.

The coating may remain underneath the edge of the pocket. In many cases, it is viewed as practical to join the surface of the coating in a flush manner to the surface surrounding the pocket. The transition from the lateral surface or flat surface of the gripper body to the surface of the anti-wear element is then stepless. Such a stepless transition can also be created on the lower narrow side of the basic tool body.

Beyond this, it is possible to make the coating slightly elevated. In so doing, the transition from the flat side to the coating material may be selected so as to have a rounded elevation. It is also possible to fully or partially eliminate the overhang of coating material in order to form, for example, a defined step height or a continuous transition between the flat side of the basic body of the tool and the coating.

Preferably, the coating is micro-porous. In so doing, the coating may accommodate minute amounts of lubricant that effect an emergency lubrication and prevent or minimize a deterioration of the surface of the coating due to the abrasive effect of a cutting knife.

Additional details of advantageous embodiments of the invention are the subject matter of the drawings, the description or the claims. The description is restricted to essential aspects of the invention and to miscellaneous situations. The drawings disclose additional details and are to be considered as being supplementary.

### BRIEF DESCRIPTION OF THE DRAWINGS

FIG. 1 is a perspective illustration of a tool in the form of a loop gripper for a tufting machine.

FIG. 2 is a side view of the loop gripper in accordance with FIG. 1.

FIG. 3 is a sectional view, along line of the loop gripper in accordance with FIG. 2.

FIG. 4 is a sectional view of a detail, along line IV-IV in FIG. 1, of the loop gripper in accordance with FIG. 2.

FIGS. 5 and 6 are sectional views, along line V-V in FIG. 2, of modified embodiments of the loop gripper in accordance with FIG. 2.

FIG. 7 is a simplified perspective illustration of a tool in the embodiment of a knife.

### DETAILED DESCRIPTION OF THE INVENTION

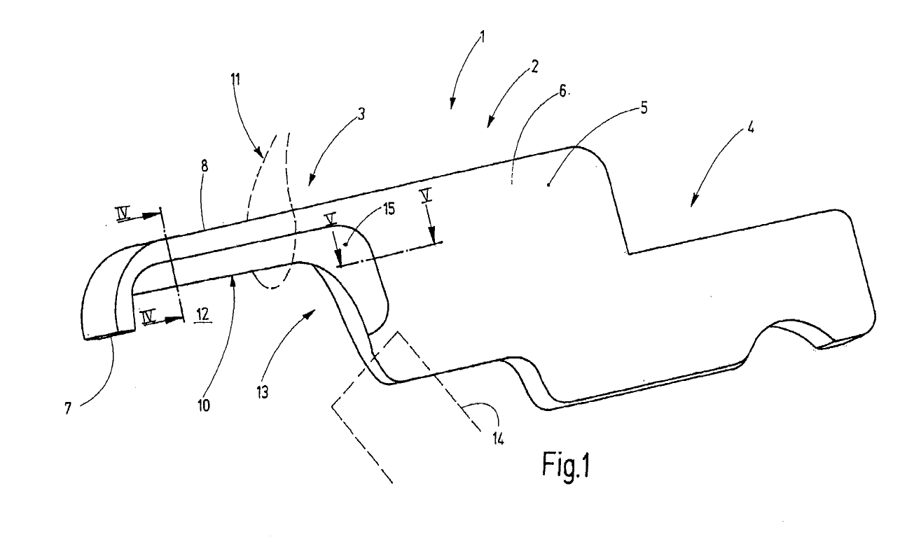

A tool in accordance with the invention will be explained with the use of a loop gripper as illustrated in FIG. 1, whereby such a loop gripper may be used, for example, in a tufting machine. In the tufting machine, the loop gripper is used to pick up and temporarily hold thread loops that have been punched through a carrier material.

The loop gripper 1 comprises a basic tool body, a gripper body 2, whose front section forms a section 3 for picking up loops and whose rear section forms a holding or fastening section 4. The gripper body 2 consists, for example, of a slightly flexible steel. Said gripper body 2 has, for example, an essentially flat lateral surface 5 which—in FIG. 1—faces the viewer, as well as—on the opposite side—a lateral surface 6 that is hidden from the viewer. The latter may also be flat or also be provided with a step, e.g., between the fastening section 4 and the loop pick-up section 3. The fastening section 4 and the loop pick-up section 3 may have different thicknesses, whereby the term “thickness” is understood to mean the respective distance between the lateral surfaces 5, 6. The loop pick-up section 3 resembles a finger. For example, as shown by FIG. 3, the lateral surfaces 5, 6 extend up to its front, downward bent end 7. At the top, the loop pick-up section 3 has a narrow side 8. The lateral surface 6 may be provided with an inclination 9 that forms a transition to the lower narrow side 10. This narrow side 10 picks up the head of a thread loop 11 that is indicated in dashed lines in FIG. 1. The preferably straight narrow side 10 is narrower than the preferably parallel-extending narrow side 8. The loop pick-up section 3 can pick up several loops corresponding to the loop 11.

Viewed from the bottom, the narrow side 10 delimits a loop pick-up space 12 which, on one side, is delimited by the hook-like end 7, in upward direction by the narrow side 10 and, on the side opposite the end 7, by a step 13. The loops 11 picked up by the loop pick-up space 12 can be cut open, e.g., by a suitable knife, if cut pile is to be produced within the framework of a tufting process. In FIG. 1, such a knife is indicated by its contour 14 represented in dashed lines. On its front side, said knife has a cutting edge that can be used—by interacting with the loop gripper 1—for cutting open the loops 11.

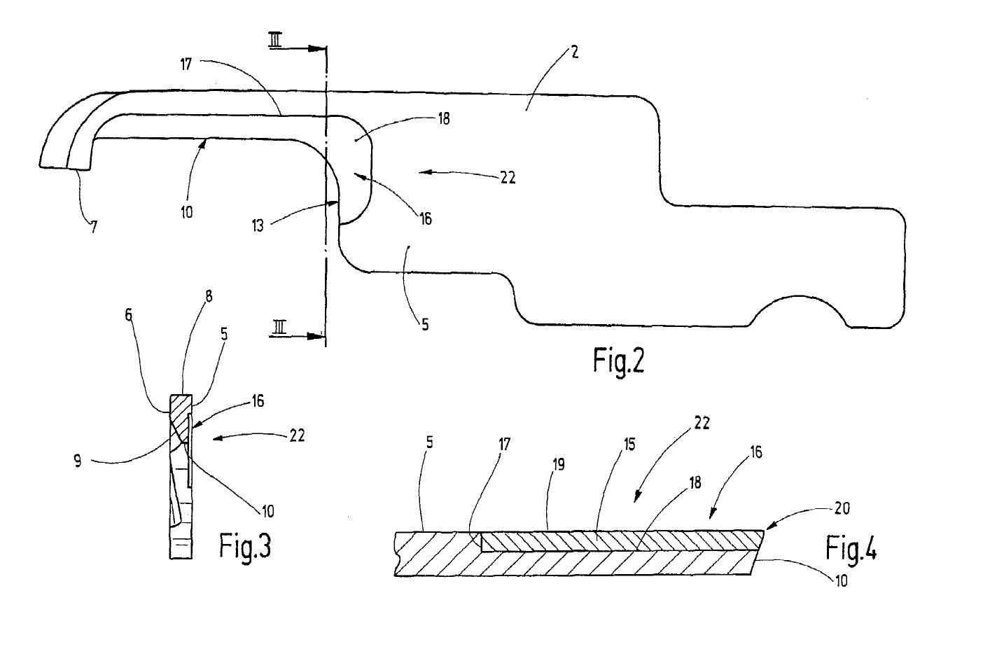

The loop gripper 1 is provided with an anti-wear element 15 that protects or represents the regions of the lateral surface 5 and, optionally also the narrow side 10, that are subject to special stress. For example, the anti-wear element 15 is a thin ceramic layer that is provided in a corresponding region 22 of a corresponding pocket 16 of the gripper body 2. This pocket 16 can be seen in FIGS. 2 and 3. This pocket extends as a shallow recess over a part of the lateral surface 5 and is circumscribed by an edge 17 that is formed by a step, for example. The edge 17 may extend, starting from the front end 7, above the lower narrow side 10 and parallel thereto and again meet the narrow side of the gripper body at the step 13. The bottom 18 of the pocket 16 is preferably flat. The bottom 18 may be aligned parallel to the flat side 5, as is obvious from FIG. 3 and also from FIG. 4. The depth of the pocket 16 or the height of the step formed by the edge 17 may be minimal and be limited, for example, to a few tenths of a millimeter, e.g., two tenths of a millimeter.

The anti-wear element 15 is formed by a sprayed-on coating that preferably completely fills the pocket 16, i.e., forms a cover without discontinuities on the bottom 18. In addition, the coating has a surface 19 that is flush with the flat side 5, said surface preferably also being flat.

Thus the coating is freely exposed on the lateral side 5. In addition, the narrow side of the coating that directly adjoins the narrow side 10 is freely exposed. There, a cutting edge 20 may be formed, as is shown by FIG. 4. This cutting edge may be obtained, for example, by grinding the narrow side 10 following the application of the coating.

The loop gripper 1 is manufactured as follows:

First, the gripper body 2 is made available in that the pocket 16 shown in FIG. 2 is being provided or has been provided. Then, a spraying process is used to produce a suitable anti-wear element 15, i.e., a suitable coating in the pocket 16, in such a manner that the pocket 16 is largely filled by said coating. In so doing, the bottom 18 is preferably fully covered by the coating. The thickness of the coating is preferably selected in such a manner that it reaches or exceeds the edge 17. Coating materials that can be used are melt-deposited ceramic powder, aluminum oxide powder, or also any other hard oxidic or hard ceramic, powdery materials that are melt-deposited in the plasma jet. The materials are spun by the plasma jet to the bottom 18 and onto the layer building up there, and are shock-cooled upon impinging on the cold gripper body 2. A hard layer that is firmly adhering to the bottom 18 is built up. The flat side 5, i.e., the surface 19, may be machined later, for example, by grinding, polishing, lapping or the like. In addition, it may optionally be machined later on the narrow side 10, for example by grinding, polishing, lapping, etc. If necessary, it is also possible to produce the cutting edge 20 in this manner. In addition, the cutting edge 20 may be provided, as indicated in FIG. 4, with a defined but very small radius of curvature. The radius of curvature is preferably so small that the cutting edge 20 can be viewed as being “sharply” ground.

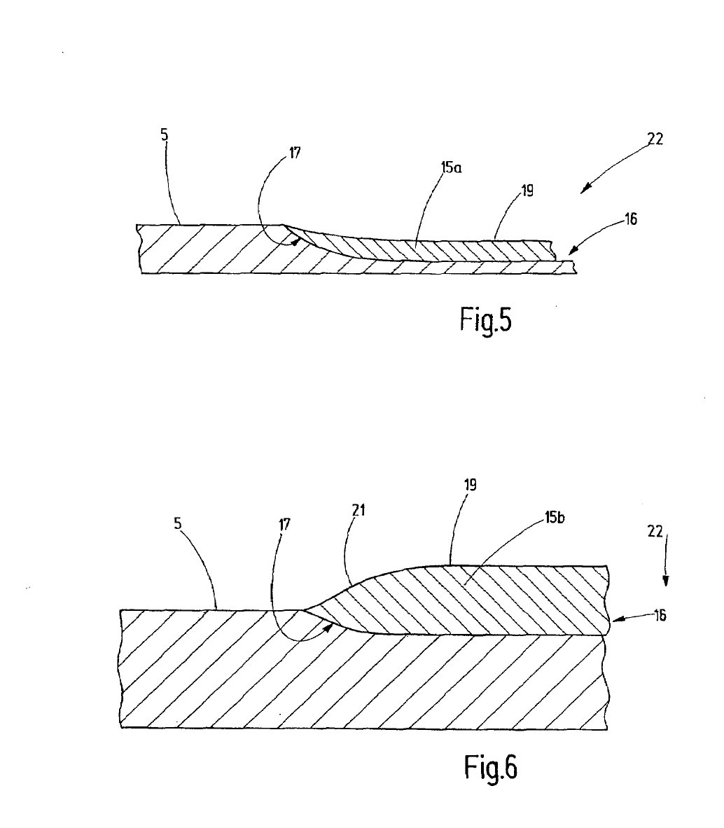

FIGS. 5 and 6 show modifications of different embodiments of the pocket 16, the edge 17 and of the anti-wear element 15a, 15b. As is obvious, the edge 17 need not necessarily be configured as a steep step. As indicated in FIG. 5, said edge may also flatten gradually. As is also indicated in FIG. 5, the surface 19 may also be somewhat below the lateral surface 5 and its edge may still adjoin—due to rounded area—the lateral surface 5 in a flush manner.

Alternatively, it is possible in accordance with FIG. 6 to select the layer thickness of the anti-wear element 15b to be larger than the depth of the pocket 16. This is true of the embodiments with the gradually flattening edge 17, as well as of the embodiments with steep step-shaped edge 17. In this case, the transition from the lateral surface 5 to the surface 19 may occur in an S-shaped rounded region 21, as is shown by FIG. 6.

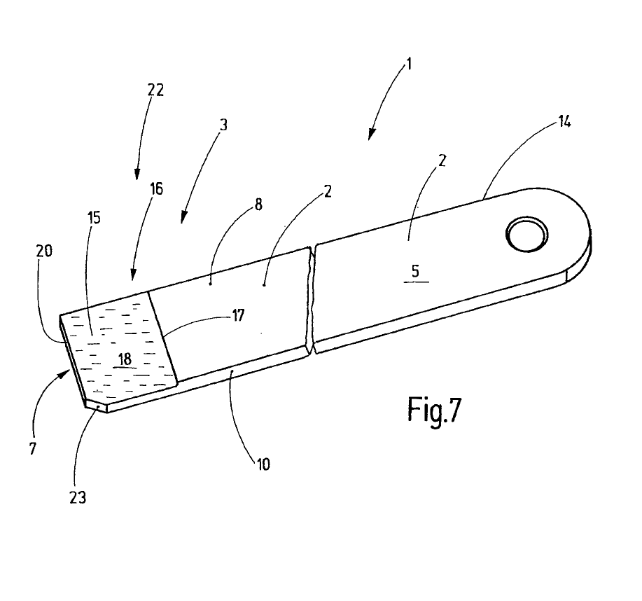

FIG. 7 shows another exemplary embodiment of a tool which is used, for example, in the manufacture of carpet goods having a velour-like surface. In this case, the tool cuts open the produced loops and thus acts like a knife. To the extent that the part 1 shown in FIG. 7 corresponds to the above-described parts 1, the same reference signs apply, and reference is made to the corresponding previous description. The knife has a basic tool body 2 whose front section forms a section 3 for processing loops and whose rear section forms a holding or fastening section 4. The section 3 has a rectangular shape and essentially represents the extension of the fastening section 4. Section 3 is delimited by the flat lateral surfaces 5 and 6, as well as by the narrow sides 8 and 10, as well as by its end 7. A cutting edge 20 may be provided on the end 7. The narrow side 10 and the end 7 are joined by a narrow side 23. In so doing, the narrow side 23 is at an angle relative to the narrow side 10 and to the end 7. A recess is formed that is disposed to optimize the cutting function of the tool 1 because said tool is arranged at an angle relative to the loop gripper 1 in the tufting machine.

The tool 1 is provided with an anti-wear element 15 that protects or represents the regions of the lateral surface 5 of the narrow side 10 and, in particular, the end 7, that are subject to special stress. The anti-wear element 15 is applied in an appropriate region 22 of a corresponding pocket 16 of the basic body 2. This pocket 16 extends as a flat recess over the lateral surface 5 and is delimited by the edge 17 that, for example, is formed by a step. The edge 17 connects the narrow sides 10 and 8, so that the pocket 16 takes up the full width of the tool 1. The distance between the narrow side 10 and the narrow side 8 is viewed as the width of the tool 1. The pocket 16 is a pocket that is open toward three sides and is delimited by the edge 17 in longitudinal direction. Consequently, it is possible for the anti-wear element 15 to extend beyond the pocket 16 and, in at least in some parts, cover the narrow sides 8 and 10, as well as the end 7, and the cutting edge 20. The depth of the pocket 16 or the height of the step formed by the edge 17 may be minimal and, for example, may be limited to a few tenths of a millimeter, e.g., two tenths of a millimeter. The above description applies to the anti-wear element 15. It may cover, partially or fully, the flat side 5, the narrow sides 8, 10, 23 as well as the end 7.

Additional modifications are possible within the framework of the present disclosure and may comprise the most diverse tools for the manufacture and processing of stitches and loops.

In accordance with the invention a tool 1 is being suggested, said tool having a wear-minimizing coating on its basic tool body 2, said wear-minimizing coating acting as an anti-wear element 15. In order to accommodate this coating, the basic tool body 2 is provided with a recess at a suitable location, whereby the coating is built up on the bottom of said recess, for example, by plasma-spraying. Preferably, an oxide-ceramic material is used for the coating.

It will be appreciated that the above description of the present invention is susceptible to various modifications and changes, and the same are intended to be comprehended within the meaning and range of equivalents of the appended claims.

### LIST OF REFERENCE NUMERALS

1 Tool, loop gripper
2 Basic tool body, gripper body
3 Section
4 Fastening section
5, 6 Lateral surfaces
7 End
8 Narrow side
9 Inclination
10 Narrow side
11 Loops
12 Loop pick-up space
13 Step
14 Contour
15 Anti-wear element
16 Pocket
17 Edge
18 Bottom
19 Surface
20 Cutting edge
21 Region
22 Region
23 Narrow side

What is claimed is:

1. Tool (1) for a textile machine, in particular, for a tufting machine,
with a basic tool body (2) having a fastening section (4) and a section (3),
with a region (22) provided on the section (3),
characterized in that the region (22) comprises an anti-wear element (15) in the form of a spray-deposited coating.

2. Tool in accordance with claim 1, characterized in that the region (22) is configured as a pocket (16).

3. Tool in accordance with claim 2, characterized in that the pocket (16) is provided in a lateral surface (5) of the gripper body (2) in order to define a recessed region in the lateral surface (5).

4. Tool in accordance with claim 2, characterized in that the pocket (16) extends through a narrow side (8, 10, 23) on the lateral surface (5).

5. Tool in accordance with claim 2, characterized in that the pocket (16) is filled by the anti-wear element (15).

6. Tool in accordance with claim 2, characterized in that the anti-wear element (15) is flush with the lateral surface (5) circumscribing the pocket (16).

7. Tool in accordance with claim 2, characterized in that the anti-wear element (15) is raised above the lateral surface (5) circumscribing the pocket (16).

8. Tool in accordance with claim 1, characterized in that a cutting edge (20) is provided on the anti-wear element (15).

9. Tool in accordance with claim 1, characterized in that the anti-wear element (15) is ground at least in sections.

10. Tool in accordance with claim 1, characterized in that the anti-wear element (15) is a ceramic coating.

11. Tool in accordance with claim 1, characterized in that the anti-wear element (15) is a metallic coating.

12. Tool in accordance with claim 1, characterized in that the anti-wear element (15) is applied by means of a plasma-spraying process.

13. Method for the production of a tool, said method comprising the following steps:
providing a basic tool body (2) of a first material,
forming a region (22) on the lateral surface (5) of the basic tool body (2),
applying an anti-wear element (15) of a second material in the region (22).

14. Method in accordance with claim 13, whereby the first material is a metal and the second material is a ceramic hard material displaying a wear resistance greater than that of the metal.

15. Method in accordance with claim 13, whereby the second material is applied by plasma-spraying process or by arc-spraying process.
